(19) United States
(12) Patent Application Publication
(10) Pub. No.: US 2006/0285058 A1
(43) Pub. Date: Dec. 21, 2006

(54) Fabricating method of liquid crystal display device

(75) Inventor: Hyun Jun Kim, Gumi-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/208,240

(22) Filed: Aug. 17, 2005

(30) Foreign Application Priority Data
Jun. 20, 2005 (KR) P2005-53149

(51) Int. Cl. G02F 1/1339

(52) U.S. Cl. 349/156

(57) ABSTRACT

A fabrication method of a liquid crystal display device using a liquid crystal dropping process is provided. A substrate includes first, second, and third color filter layers. A spacer is formed to maintain a cell gap and disposed longitudinally adjacent one of the first, second, and blue color filter layers. To determine a dropped amount of liquid crystal, a surface (A) of a liquid crystal cell is multiplied by a height (H) of the liquid crystal cell. The height (H) of the liquid crystal cell is decided by adding a height (D) of the spacer to a step difference between the color filter layers. When deciding the height (H) of the liquid crystal cell, the step difference between the color filter layers is considered. Accordingly, the dropped amount of liquid crystal may be accurately determined.

This application claims the benefit of the Patent Korean Application No. P2005-53149, filed on Jun. 20, 2005, which is incorporated by this reference in its entirety.

### BACKGROUND

1. Technical Field

The invention relates to a fabrication method of a liquid crystal display (LCD) device, and more particularly, to a fabrication method of a liquid crystal display device using an accurate amount of liquid crystal dropping.

2. Discussion of the Related Art

Ultra thin flat panel displays includes a slim display screen having a thickness of a few centimeters (cm) or less. Liquid crystal display devices are one of ultra flat panel displays and have a particular advantage that they consume a low power due to their low driving voltage. Further, liquid crystal display devices are portable such that they may be extensively used in various fields, such as laptop computers, monitors, spaceships, aircrafts, and so on.

The liquid crystal display devices include a lower substrate having a thin film transistor and a pixel electrode formed thereon. The liquid crystal display devices also include an upper substrate having a common electrode formed thereon. A liquid crystal layer is formed between the upper and lower substrates. The pixel electrode and the common electrode generate an electric field between the two substrates, so as to operate and/or drive the liquid crystal. Upon driving of the liquid crystal, light transmissivity may be controlled and the liquid crystal display device is able to display an image. Liquid crystal display devices may be made with a vacuum injection method using a capillary phenomenon. Pressure difference is used for forming the liquid crystal layer between the upper and lower substrates.

In the vacuum injection method, the lower substrate and the upper substrate are first formed. The lower substrate includes a thin film transistor and a pixel electrode, and the upper substrate includes a color filter layer and a common electrode. A sealant having an injection hole is formed on one of the two substrates to attach the two substrates each other. After attaching the two substrates, the sealant is hardened and the substrates are bonded. Subsequently, the bonded substrates are placed in a vacuum chamber to maintain a space between the two substrates in vacuum. Liquid crystal is then dipped into the space. When the space between the substrates is in vacuum as described above, the liquid crystal is quickly absorbed into the space through the injection hole due to the capillary phenomenon. As a result, the liquid crystal is injected between the two substrates.

In the vacuum injection method, as a surface area of the display screen becomes larger, a process time for injecting the liquid crystal between the substrates is protracted and productivity decreases. Unlike the vacuum injection method, a liquid crystal dropping method may provide a reduced process time.

In the liquid crystal dropping method, liquid crystal is dropped on one of the substrates. When using the liquid crystal dropping method, the liquid crystal is dropped directly on the substrate. Accordingly, the process does not require the step of injecting the liquid crystal between the substrates and the fabrication process may be simplified. In the liquid crystal dropping method, however, the amount of dropped liquid crystal may not be accurately calculated in advance.

In the vacuum injection method, the upper and lower substrates are bonded and liquid crystal is filled between the bonded substrates through the injection hole. The amount of liquid crystal may not need determination. To the contrary, in the liquid crystal dropping method, the substrates are bonded after dropping the liquid crystal. The dropping amount of liquid crystal may need to be determined in advance. If the dropping amount is less than the required amount of liquid crystal, a liquid crystal deficient area may occur within a liquid crystal cell. If the dropping amount is greater than the required amount of liquid crystal, a liquid crystal excessive area may occur within the liquid crystal cell. For liquid crystal deficient or excessive area, the picture quality of the liquid crystal display device may deteriorate.

The dropping amount of liquid crystal may be determined by calculating the volume within the liquid crystal cell. The dropping amount of liquid crystal may be calculated by multiplying the surface of the liquid crystal cell by the height of the liquid crystal cell. The height of the liquid crystal cell corresponds to the height of the spacer, which is formed to maintain the cell gap of the liquid crystal cell. The dropping amount of liquid crystal is calculated by multiplying the surface of the liquid crystal cell by the height of the spacer.

FIG. 1A is a cross-sectional view of a liquid crystal display device 100. A lower substrate 10 and an upper substrate 30 are bonded each other by a sealant 70. A liquid crystal layer 50 is formed between the two substrates 10 and 30. The upper substrate 30 includes a light-shielding layer 32, red, green, and blue color filter layers 34a˜34c and a common electrode 36. A spacer 38 is formed between the common electrode 36 and the lower substrate 10.

The liquid crystal layer 50 is formed in a space within a liquid crystal cell. By calculating the volume of the space, the amount of liquid crystal may be determined. The volume of the space within the liquid crystal cell is calculated by multiplying the surface of the liquid crystal cell by its height. The height of the liquid crystal cell corresponds to the height of the spacer 38. The dropping amount of liquid crystal may be equal to the surface of the liquid crystal cell multiplied by the height of the spacer 38.

In determining the dropping amount, a step difference may occur during the fabrication process. The step difference occurs between the color filters during deposition of the color filter layers 34a-34c. In light of the step difference, when applying the calculated amount to the actual fabrication process, a deficient area or an excessive area may occur due to an incorrectly calculated amount of liquid crystal.

The color filter layers 34a˜34c repeatedly form colors of red (R), green (G), and blue (B). Individual color filter layers of red (R), green (G), and blue (B) are deposited. As shown in FIG. 1B, when performing the three deposition processes, the height of each color may not be uniform, which eventually causes a step difference (h) between each color filter layer. When such step difference (h) occurs, the spacer 38 may be formed longitudinally adjacent the color filter layer having the step difference (e.g., the blue color filter layer). The height of the spacer 38 may not be identical to the height of the entire liquid crystal cell. Moreover, the height of the liquid crystal cell in the area of the red and green color filter layers may be higher than the height of the spacer 38. The difference in height is equal to the step difference (h). In this case, the calculated amount of liquid crystal becomes less than the actually required amount, thereby resulting in a liquid crystal deficient area. When the spacer 38 is formed adjacent the red or green color filter layer, the calculated amount of liquid crystal becomes greater than the required amount. Thus, a liquid crystal excessive area may occur.

Accordingly, there is a need of a fabrication method of a liquid crystal display device that substantially obviates drawbacks of the related art.

### SUMMARY

By way of introduction only, in one embodiment, a method for fabricating a liquid crystal display device is provided. In the fabrication method, a first substrate and a second substrate are prepared. A light-shielding layer and a plurality of color filter layers are formed on the first substrate. A spacer is supplied between the first and second substrates to maintain a cell gap. An amount of liquid crystal is determined based on a surface (A) of a liquid crystal cell and a height (H) of the liquid crystal cell. The height (H) of the liquid crystal cell includes a height (D) of the spacer and a step difference of the color filter layer. The determined amount of the liquid crystal is dropped on one of the first and second substrates.

In other embodiment, a liquid crystal displace device includes a pair of substrates, a color filter layer, a spacer and a liquid crystal. The pair of substrates includes a first substrate and a second substrate. The color filter layer is formed on the first substrate. The spacer separates the first substrate and the second substrate with a predetermined cell gap. The liquid crystal is interposed in the cell gap. A dropping amount of the liquid crystal is determined based on a volume of the cell gap and the volume of the cell gap is determined by a height of the spacer, a surface of a liquid crystal cell and at least one step difference of the color filter layer.

It is to be understood that both the foregoing general description and the following detailed description of preferred embodiments are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is a cross-sectional view of a related art liquid crystal display device;

FIG. 1B is a cross-sectional view illustrating a step difference (h) of the liquid crystal display device of FIG. 1A;

FIG. 2 to FIG. 4 are cross-sectional views of color filter layers having various forms of a step difference; and

FIG. 5A to FIG. 5C are perspective views illustrating a fabrication process of a liquid crystal display device.

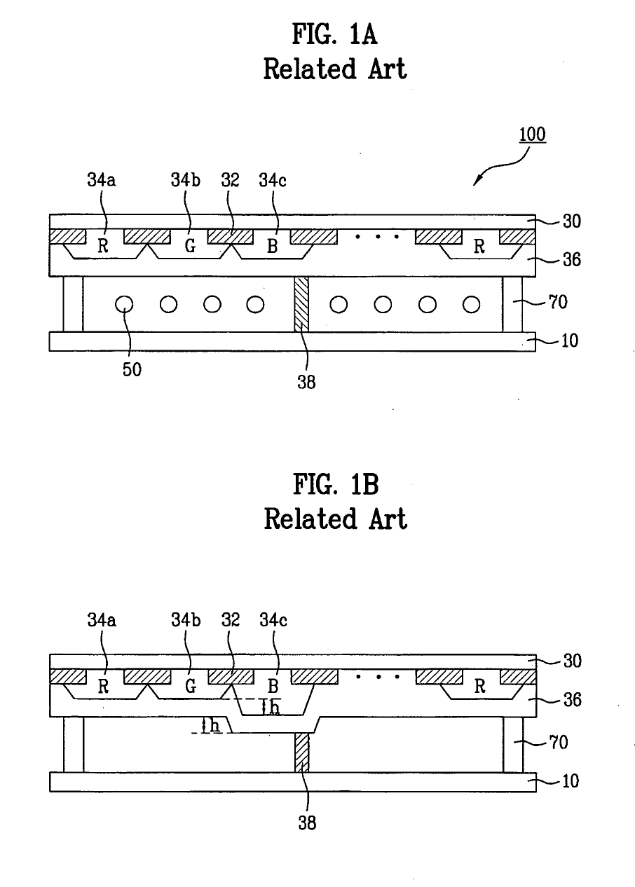

### DETAILED DESCRIPTION OF PREFERRED EMBODIMENTS

Reference will now be made in detail to the preferred embodiments, examples of which are illustrated in the accompanying drawings. Wherever possible, the same reference numbers will be used throughout the drawings to refer to the same or like parts.

A dropped amount of liquid crystal may be determined as follow.

### Calculation of Dropped Amount of Liquid Crystal

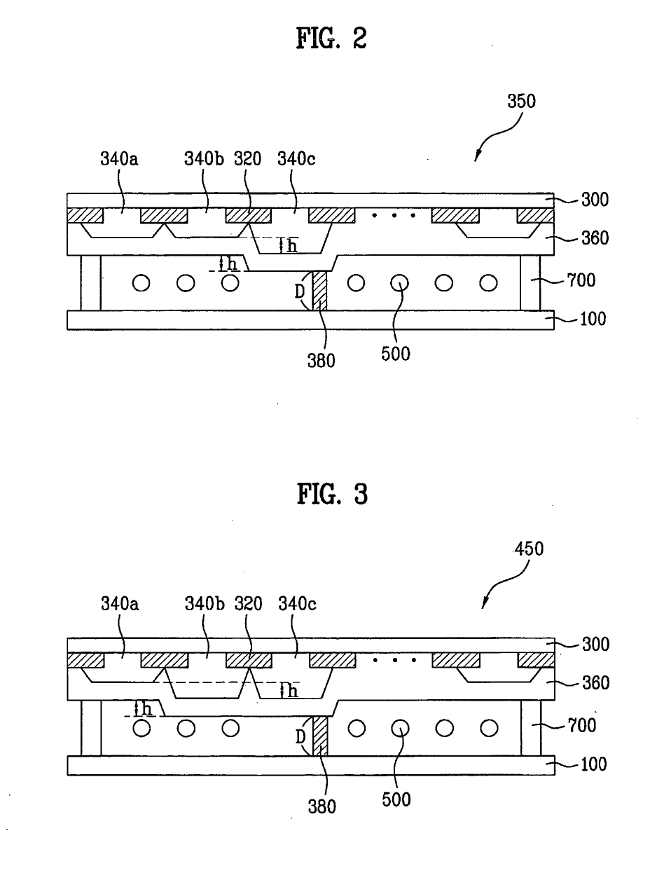

FIGS. 2-4 illustrate a color filter layer having various forms of a step difference. In a liquid crystal display device 350 shown in FIG. 2, a lower substrate 100 and an upper substrate 300 are bonded each other by a sealant 700. A liquid crystal layer 500 is formed between the two substrates 100 and 300. A light-shielding layer 320, first, second, and third color filter layers 340a, 340b, and 340c, and a common electrode 360 are sequentially formed on the upper substrate 300. In other embodiment, the common electrode 360 may be formed on the lower substrate 100 for an In-Plane Switching (IPS) mode liquid crystal display device. The three color filter layers 340a, 340b and 340c may include red, green and blue color filters, but not limited thereto.

A spacer 380 is formed between the two substrates 100 and 300. In particular, the spacer 380 is formed longitudinally adjacent the third color filter layer 340c. In other embodiments, the spacer 380 may be formed longitudinally adjacent the first color filter layer 340a and/or the second color filter layer 340b. A step difference (h) is formed between the third color filter layer 340c and other two color filter layers (e.g., the first color filter layer 340a and the second color filter layer 340b). The dropped amount of liquid crystal may be obtained by calculating the volume of the liquid crystal cell, i.e., the surface of the liquid crystal cell multiplied by the height of the liquid crystal cell.

The spacer 380 is formed adjacent the third color filter layer 340c among three color filter layers. The height of the area corresponding to ⅓ of the entire liquid crystal cell may be calculated as the height (D) of the spacer 380. The height of the area corresponding to the remaining ⅔ of the liquid crystal cell may be calculated as an added value (D+h) of the height (D) of the spacer 380 and the step difference (h). The entire height (H) of the liquid crystal cell may be calculated as:
H=⅓(D)+⅔(D+h) (1)
The value h also may represent an average value (X) of the entire step difference.

In FIG. 3, a liquid crystal display device 450 is identical to that of FIG. 2 except for a step difference between the color filter layers 340. Referring to FIG. 3, there is no step difference between the third color filter layer 340c and the second color filter layer 340b. The spacer 380 is formed longitudinally adjacent the third color filter layer 340c and the second color filter layer 340b. A step difference (h) develops, however, between the first color filter layer 340a and the third color filter layer 340c.

The spacer 380 is formed adjacent the third color filter layer 340c, and the height of the area corresponding to ⅓ of the entire liquid crystal cell may be calculated as the height (D) of the spacer 380. The height of the area of the second color filter layer 340b corresponding to ⅓ of the entire liquid crystal cell also may be calculated as the height (D) of the spacer 380. The height of the area of the first color filter layer 340a corresponding to the remaining ⅓ of the entire liquid crystal cell may be calculated as an added value (D+h) of the height (D) of the spacer 380 and the step difference (h). The entire height (H) of the liquid crystal cell is:
H=[⅓(D)+⅓(D)+⅓(D+h)]=[⅓(D)+⅓(2D+h)]=[⅓(D)+⅔(D+h/2)] (2)
where h/2 represents an average value (X) of the entire step difference.

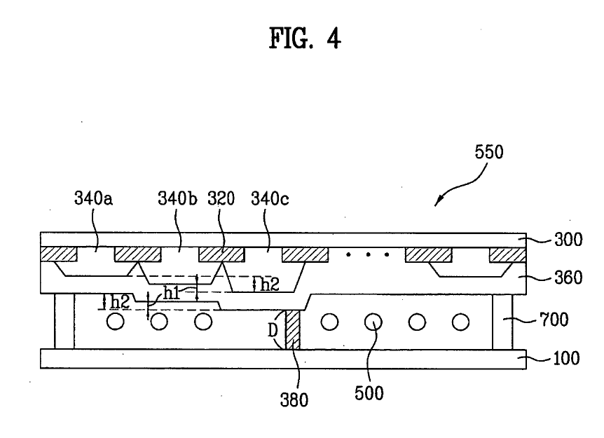

In FIG. 4, a liquid crystal display device 550 is identical to that of FIG. 3 except for the step difference between the color filter layers 340. Referring to FIG. 4, a step difference (h1) is formed between the third color filter layer 340c and the second color filter layer 340b, and a step difference (h2) is formed between the third color filter layer 340c and the first color filter layer 340a. When a step difference between the color filter layers is formed as described above, the method for calculating the height of the liquid crystal cell is as follows.

The spacer 380 is formed longitudinally adjacent the third color filter layer 340c among the three color filter layers. The height of the area corresponding to ⅓ of the entire liquid crystal cell may be calculated as the height (D) of the spacer 380. Then, the height of the area of the second color filter layer 340b corresponding to another ⅓ of the entire liquid crystal cell can be calculated as an added value (D+h1). Finally, the height of the area of the first color filter layer 340a corresponding to the remaining ⅓ of the entire liquid crystal cell may be calculated as an added value (D+h2). The entire height (H) of the liquid crystal cell is:
H=[⅓(D)+⅓(D+h1)+⅓(D+h2)]=[⅓(D)+⅓(2D+h1+h2)]=[⅓(D)+⅔(D+(h1+h2)/2)] (3)
where (h1+h2)/2 represents an average value (X) of the entire step difference.

As a result, when the spacer 380 is formed above one of the color filter layers, the height (H) of the liquid crystal cell may be calculated as:
H=⅓(D)+⅔(D+X) (4)

In FIGS. 2 to 4, the spacer 380 is shown to be formed longitudinally adjacent the third color filter layer 340c only. In other embodiment, the spacer 380 may be formed above the first color filer layer 340a and/or the second color filter layer 340b as well. FIGS. 2 to 4 illustrate the spacer 380 as being formed longitudinally adjacent the color filter layer which is higher than other color filter layers. The average value (X) of the step difference is added to the height (D) of the spacer. In other embodiment, the spacer 380 may be formed longitudinally adjacent a color filter layer that is shorter than other color filter layers. In that embodiment, the average value (X) of the step difference may be subtracted from the height (D) of the spacer. For this reason, a negative value may be used for the average value (X) of the step difference in the equations (1)˜(4).

Alternatively, or additionally, the spacer 380 may be formed longitudinally adjacent a color filter layer that is shorter than the other color filter layer and taller than another color filter layer. A first step difference occurs between the color filter layer and the other color filter layer. A second step difference occurs between the color filter layer and the another color filter layer. The average value (X) of the step difference may be added or subtracted to the height (D) of the spacer by comparing the first step difference and the second step difference.

### Fabrication Method of Liquid Crystal Display Device

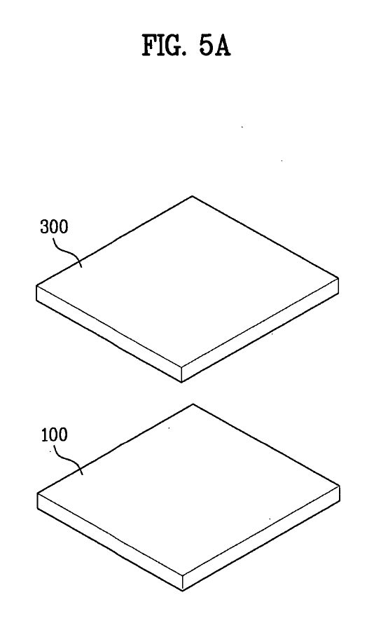

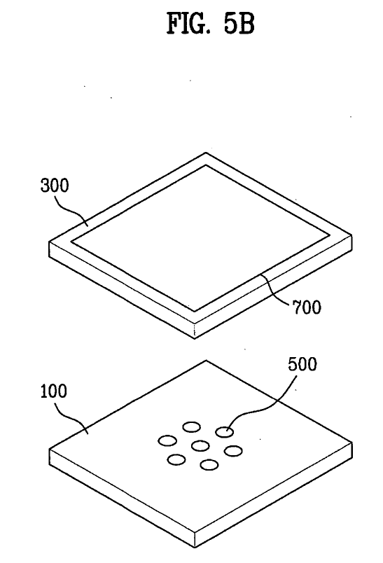

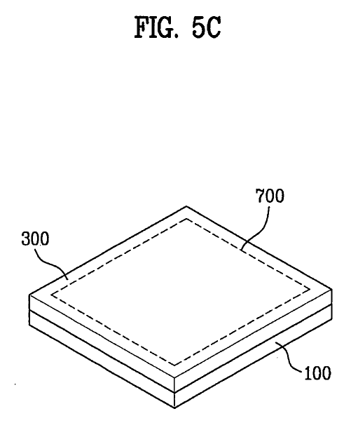

FIG. 5A to FIG. 5C are perspective views illustrating a fabricating process of the liquid crystal display device 350, 450 and 550 of FIGS. 2-4. In FIGS. 5A to 5C, only one liquid crystal cell is illustrated. However, a plurality of liquid crystal cells may be formed in accordance with the size of the substrate.

Referring to FIG. 5A, a lower substrate 100 and an upper substrate 300 are prepared. Although not shown, a plurality of gate lines and data lines intersecting each other to define a pixel area are formed on the lower substrate 100. A thin film transistor is formed on each intersection between the gate line and the data line. The thin film transistor includes a gate electrode, a semiconductor layer, a source electrode, and a drain electrode. A pixel electrode that is connected to the thin film transistor is formed in the pixel area.

In addition, a light-shielding layer is formed on the upper substrate 300. The light-shielding layer prevents light from leaking out of the area for forming the gate line, the data line, and the thin film transistor. Then, first, second, and third color filter layers are formed on the light-shielding layer. A common electrode is formed on the color filter layers. A step difference may occur between the color filter layers.

When forming an In-Plane Switching (IPS) mode liquid crystal display device, the common electrode is formed on the lower substrate 100 instead of the upper substrate 300. More specifically, the common electrode is formed to be parallel to the pixel electrode, so as to induce a transverse electric field between the pixel electrode and the common electrode.

A spacer for maintaining a cell gap of a liquid crystal cell is formed on one of the lower substrate 100 and the upper substrate 300. The spacer is formed longitudinally adjacent one of the first, second, and third color filter layers. The color filter layers may include R, G and B color filters. The spacer may be formed in the form of a ball spacer or a column spacer. The column spacer may be more desirable because it provides a uniform gap to a large surface.

An orientation layer is formed on one of the lower substrate 100 and the upper substrate 300, which is used for an initial orientation of the liquid crystal. The orientation layer may be formed by rubbing materials, such as polyamide or polyimide group compounds, polyvinylalcohol (PVA), polyamic acid, and so on. The orientation layer also may be formed by photo-aligning photosensitive materials, such as polyvinylcinnamate (PVCN), polysiloxanecinnamate (PSCN), cellulosecinnamate (CelCN) group compounds, etc.

Referring to FIG. 5B, liquid crystal 500 is dropped onto the lower substrate 100, so as to form a liquid crystal layer. The sealant 700 is formed on the upper substrate 300. The sealant 700 is formed on an edge portion of the upper substrate 300 in a closed pattern having no injection hole. Either a screen printing method or a dispensing method is used to form the sealant pattern. The sealant 700 is formed of a UV-hardening sealant. More specifically, the UV-hardening sealant may include either a polymer having an acrylic radical combined to each end and mixed with an initiator. Alternatively, or, additionally, a polymer may include an acrylic radical combined to one end and an epoxy radical combined to the other end, and mixed with an initiator.

The dropped amount of liquid crystal 500 is determined as described above. It is preferable to drop the adequately calculated amount of liquid crystal 500 on a center portion of the lower substrate 100. This is because the liquid crystal 500 may be contaminated in a later process, if the liquid crystal 500 is contacted with the sealant 700 before the sealant 700 is hardened. The liquid crystal 500 that is dropped on the center portion of the lower substrate 100 spreads out, even after the sealant 700 is hardened, so as to form a liquid crystal layer having a uniform density across the entire substrate.

In FIG. 5B, the liquid crystal 500 is dropped on the lower substrate 100 and the sealant 700 is formed on the upper substrate 300. In other embodiment, the liquid crystal 500 may be dropped on the upper substrate 300 and the sealant 700 may be formed on the lower substrate 100. Further, the liquid crystal 500 and the sealant 700 also may be dropped and formed on the same substrate.

In FIG. 5C, the lower substrate 100 and the upper substrate 300 are attached each other. The lower substrate 100 having the liquid crystal dropped thereon is placed below. The upper substrate 300 is turned over so that the layer forming surface (i.e., the surface having the sealant formed thereon) faces the upper surface of the lower substrate 100.

Subsequently, although not shown, a process of hardening the sealant 700 is further applied after the attaching process. The process of hardening the sealant 700 is applied in accordance with the material used to form the sealant 700. As described above, in case of the UV-hardening sealant, the sealant is hardened by using only a UV irradiation process. Alternatively, or additionally, both an UV irradiation process and a heating process may be applied.

If UV rays are irradiated to harden the sealant, irradiating the UV rays on the entire surface of the bonded substrate may deteriorate the characteristics of devices such as the thin film transistor formed on the substrate. Furthermore, a pretilt angle of the orientation layer for initially orienting the liquid crystal may be changed. Therefore, when irradiating UV rays to harden the sealant, it is preferable to irradiate the UV rays only on the area of the sealant by covering the remaining area with a mask.

As described above, the fabrication method of the liquid crystal display device has advantages that the dropped amount of liquid crystal may be accurately calculated. In addition to the height of the spacer, the step difference between the color filter layers is considered.

It will be apparent to those skilled in the art that various modifications and variations may be made without departing from the spirit or scope of the inventions. Thus, it is intended that modifications and variations of this invention are available provided they come within the scope of the appended claims and their equivalents.

What is claimed is:

1. A method for fabricating a liquid crystal display device, comprising:
preparing a first substrate and a second substrate;
forming a light-shielding layer and a plurality of color filter layers on the first substrate;
supplying a spacer between the first and second substrates to maintain a cell gap;
determining an amount of liquid crystal based on a surface (A) of a liquid crystal cell and a height (H) of the liquid crystal cell, the height (H) of the liquid crystal cell including a height (D) of the spacer and a step difference between the color filter layers; and
dropping the determined amount of the liquid crystal on one of the first and second substrate.

2. The method of claim 1, wherein the spacer is disposed longitudinally adjacent to one of the color filter layers.

3. The method of claim 2, wherein determining the amount of the liquid crystal comprises determining the height (H) of the liquid crystal cell as:
H=⅓(D)+⅔(D+X)
wherein X represents an average value of the step difference, the step difference occurring between the color filter layer where the spacer is formed and other color filter layers.

4. The method of claim 1, further comprising supplying a common electrode on the color filter layers.

5. The method of claim 1, wherein supplying the spacer comprises forming the spacer with a column spacer.

6. The method of claim 1, further comprising supplying a sealant on one of the first and second substrates, the one of the first and second substrates comprising no dropped liquid crystal.

7. The method of claim 1, further comprising:
forming a sealant on one of the first and second substrate; and
attaching the first and second substrates.

8. The method of claim 7, further comprising hardening the sealant after attaching the first and second substrates.

9. The method of claim 8, wherein hardening the sealant comprises irradiating the sealant with ultraviolet (“UV”) light.

10. The method of claim 8, wherein hardening the sealant comprises a UV irradiation process and a heating process.

11. A liquid crystal displace device, comprising:
a pair of substrates comprising a first substrate and a second substrate;
a color filter layer formed on the first substrate;
a spacer separating the first substrate and the second substrate with a predetermined cell gap;
a liquid crystal interposed in the cell gap, wherein an amount of the liquid crystal is determined based on a volume of the cell gap, and the volume of the cell gap is determined by a height of the spacer, a surface of a liquid crystal cell and at least one step difference (h) of the color filter layer.

12. The device of claim 11, wherein the color filter layer comprises at least two color filter layers and the step difference (h) occurs between the color filter layer where the spacer is formed and other color filter layers.

13. The device of claim 12, wherein a height (H) of a liquid crystal cell comprises the height of the spacer and the step difference (h) and is determined as:
H=⅓(D)+⅔(D+X)
wherein D represents the height of the spacer, and X represents an average value of the step difference (h).

14. The device of claim 11, wherein the color filter layer comprise a first color filter layer, a second color filter layer and a third color filter layer.

15. The device of claim 14, wherein the step difference (h) is formed between the third color filter layer where the spacer is formed and the second color filter layer, and the height (H) of the liquid crystal cell is determined as:
H=⅓(D)+⅔(D+h)
wherein the first color filter layer and the second color filter layer have the same height.

16. The device of claim 14, wherein the step difference (h) is formed between the third color filter layer where the spacer is formed and the first color filter layer, and the height (H) of the liquid crystal cell is determined as:
H=⅓(D)+⅔(D+h/2)
wherein the second color filter layer and the third color filter layer have the same height.

17. The device of claim 14, wherein the step difference comprises a first step difference h1 and a second step difference h2, the first step difference h1 formed between the first color filter layer and the third color filter layer and the second step difference h2 formed between the second color filter layer and the third color filter layer.

18. The device of claim 17, wherein the height (H) of the liquid crystal cell is determined as:
H=⅓(D)+⅔(D+(h1+h2)/2)

19. The device of claim 11, wherein the color filter layer comprises a blue color filter layer, a red color filter layer and a green color filter layer.

20. The device of claim 11, further comprising a common electrode formed on the color filter layer.
